(19) United States
(12) Patent Application Publication
(10) Pub. No.: US 2007/0069495 A1
(43) Pub. Date: Mar. 29, 2007

(54) Air suspension system for use on a motor vehicle

(76) Inventors: Matthew C. Middlebrook, McDonough, GA (US); Brian Van Hiel, Smryna, GA (US)

Correspondence Address: BIDDLE & ASSOCIATES, 6300 POWERS FERRY ROAD, SUITE 600-183, ATLANTA, GA, 30339, US

(21) Appl. No.: 11/434,086

(22) Filed: May 15, 2006

Related U.S. Application Data
(63) Continuation-in-part of application No. 10/718,229, filed on Nov. 20, 2003, now Pat. No. 7,077,408.

(51) Int. Cl. B60G 9/00; B60G 11/00

(52) U.S. Cl. 280/124.116; 280/124.11; 280/124.162

(57) ABSTRACT

An air suspension system for a vehicle is provided and includes a torque arm that is pivotally connected to a lever arm. The lever arm is connected to a vehicle frame via a pivotal shackle. An air spring is disposed along the lever arm and extends between the vehicle frame and the lever arm.

### CROSS REFERENCE TO RELATED APPLICATIONS

This application is a continuation-in-part of co-pending and commonly assigned application Ser. No. 10/718,229, filed Nov. 20, 2003, and entitled STABILIZING AIR SUSPENSION SYSTEM, the disclosure of which is hereby incorporated herein by reference.

### FIELD OF THE INVENTION

The present invention relates to vehicle suspension systems and, more particularly, air suspension systems capable of providing improved ride and vehicle stability, as well as maintenance of a vehicles level during acceleration and deceleration.

### SUMMARY OF THE INVENTION

The present invention provides a suspension system for a motor vehicle. In one embodiment, the system includes a torque arm that is pivotally connected to a lever arm. A shackle member is provided that is pivotally connected to the lever arm. An air spring is provided. The shackle member is configured to be connected to the frame of a motor vehicle at a second point.

Other systems, methods, features, and advantages of the present invention will be or become apparent to one with skill in the art upon examination of the following drawings and detailed description. It is intended that all such additional systems, methods, features, and advantages be included within this description, be within the scope of the present invention, and be protected by the accompanying claims.

### BACKGROUND

Air suspension systems for vehicles have been previously proposed and described. One such system is generally depicted in FIG. 1. With reference to FIG. 1 it can be seen that this air suspension system includes a pair of torque rods that are pivotally attached to the axle housing and extend forward of the rear axle in a modified parallelogram linkage.

This air suspension system includes a lever arm extending rearwardly of the axle. The forward end of the lever arm is mounted underneath the axle and the rear end of the lever arm is pivoted on a hanger assembly. An air bag is mounted on the lever arm, and the air bag supports one hundred percent 100% of the load on the vehicle. Although functionally an improvement over the prior art, this type of air suspension system is bulky, mechanically complex and relatively costly to implement.

In view of the above it is clear that there exists an unaddressed need in the industry to address the aforementioned shortcoming, deficiencies and inadequacies. The present invention is directed to overcoming the aforementioned shortcoming, deficiencies and inadequacies of the prior art.

### BRIEF DESCRIPTION OF THE DRAWINGS

The invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 is a diagram depicting a side view of the prior art.

FIG. 2 is a diagram depicting a side view of one embodiment of the present invention mounted to a vehicle frame 23.

FIG. 3 is a diagram depicting a side view of one embodiment of lever arm 19.

FIG. 4 is a diagram depicting a side view of a further embodiment of lever arm 19.

FIG. 5 shows an end view of shackle 45 that is mounted on hanger bracket 56 and that supports the lever arm 19.

FIG. 6 shows a side view of a shackle 45 of FIG. 5.

FIG. 7 shows an end view of the shackle assembly 45 including the hanger bracket 29.

FIG. 8 shows an end view of the hanger bracket that is connected to the torque arm 21.

FIG. 9 shows a side view of the mounting of the hanger 20 bracket at the end of the torque arm 21.

FIG. 10 shows a side view of the mounting of the hanger bracket at a position spaced from the end of the torque arm 21.

FIG. 11A and FIG. 11B are diagrams depicting a further embodiment of the invention.

FIG. 12 is a diagram depicting further details of torque arm 210 and lever arm 190.

FIG. 13 is a diagram depicting a further embodiment of torque arm 210.

FIG. 14 is a diagram depicting a top view showing the relative alignment of torque arm 210 in relation to the lever arm 190.

FIG. 15 is a diagram depicting a top view showing the relative alignment of a torque arm 210 in relation to the lever arm 190 as provided in a further embodiment of the invention.

### DESCRIPTION OF THE INVENTION

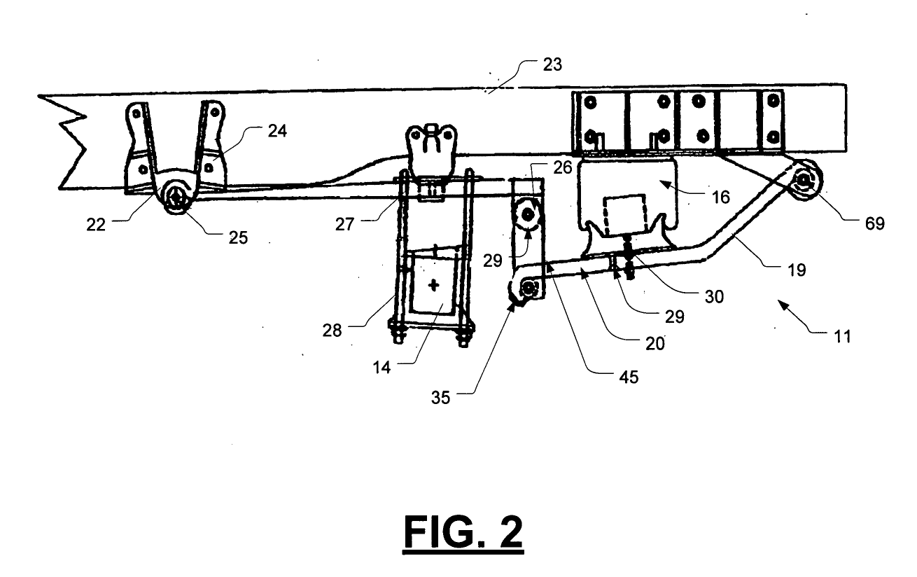

Refer now to FIG. 2, showing the inventive air suspension system 11 that is particularly useful for the medium-to-light duty vans and trucks from ¾ ton up to a 15,000 pound rear drive axle; the invention may be incorporated with any, however, including vehicles having two axles or more. The air suspension system 11 is depicted as installed on the chassis or frame 23 of a vehicle adjacent the left rear wheel 50 and on the rear axle housing 14 for rear axle 15 of the truck frame 23.

It will, of course, be understood that a similar air suspension structure which includes the other or right side of the system is installed adjacent to the right rear wheel on the rear axle 15 housing 14 of the vehicle. The air spring for the system 11 includes a vehicle air spring (bag) 16 of any suitable known type, and is selected dependent on the load rating of the vehicle. The air spring 16 is mounted on an elongated lever arm 19 by a suitable base 20 (seat), and the top of the air spring 16 mounts underneath the chassis 23, as is known. Lever arm 19 extends longitudinally of the vehicle and transverse to the rear axle housing 14.

The lever arm 19 may include one or more leafs of spring steel. The system 11 is installed in what is termed a trailing 25 lever arm position; i.e., the air spring 16 is preferably directly mounted on the lever arm 19 which is mounted to extend rearwardly of the rear axle housing 14 (rearwardly relative to the longitudinal orientation of the vehicle). An intermediate section 20 of the lever arm 19 provides the mounting area for the base of the air spring 16.

As further shown in FIG. 2, the system 11 includes a torque arm 21 that, in one embodiment, includes a single straight and elongated bar-like member; torque arm 21 may also be of spring steel. The forward end 22 of torque arm 21 includes a loop or 10 spring eye and is pivotally mounted on a bushing 25, held by a suitable bracket 24. Bracket 24 is affixed to the chassis 23. An intermediate section 27 of torque arm 21 is mounted on the axle housing 14 by a suitable U-bolt assembly 28. The rear end 26 of torque arm 21 extends rearwardly of the rear axle housing 14. A hanger bracket 29 (see also FIGS. 7 and 8) mounts a shackle assembly 45 (to be described in detail below) on the rear end 26 of torque arm 21.

Refer now generally to FIGS. 5, 6, 7 and 8. FIG. 8 shows the inverted U-shaped hanger bracket 29 that mounts onto the end 26 of torque arm 21 in the space 26A formed between the bight of the U-shape and a brace/bolt support 36. Refer back briefly to FIG. 2 that shows the position of hanger bracket 29 on the end 26 of torque arm 21.

FIG. 7 shows a bolt 50 that secures hanger bracket 29 to the end 26 of the torque arm 21. Two spaced, downwardly depending side plates 33 and 34 of bracket 29 include bolt hole 53 for receiving bolt 51 (see FIG. 8) that is used to mount a bushing 52 for supporting shackle assembly 45.

FIG. 6 shows the bushing 52 that has an internal sleeve 54 for receiving bolt 51. Bushing 52 is in turn mounted on a cylindrical bushing loop or pipe 56 that is part of the shackle assembly 45. FIG. 5 shows an end view of loop 56, and FIG. 6 shows a side view of loop 56. As best seen in FIG. 5, shackle 45 includes two spaced parallel downwardly extending support legs 39 and 40 that are welded to loop 56. A bolt 44 extends between 10 legs 39 and 40 through holes 44A, and limits upward movement of the end 35 of lever arm 19. As mentioned above the loop 56 and legs 39 and 40 are mounted on bushing 52 that is, in turn, mounted on bolt 51, see FIG. 7. The support legs 39 and 40 can articulate (swing or move back and forth) on bushing 52.

The rear end of the torque arm 26 (see FIG. 2) is received in space 26A formed between the closed part of member 31 and brace 36, and hanger bracket 29 is held in fixed position by bolt 50. FIG. 7 shows that shackle assembly 45 includes the hanger 20 bracket 29; that is, the hanger bracket 29 is a part of the overall shackle assembly 45. A steel sleeve spacer/bushing 47 is mounted at the lower end of the shackle 45 by a bolt 46 extending between legs 39 and 40. Bolt 46 extends through holes 46A in legs 39 and 40. Sleeve spacer/bushing 47 and bolt 46 25 provide the support for the end 35 of the lever arm 19 (see FIG. 6 2) in the space 35A formed between the legs 39 and 40, see also FIG.9.

As seen from FIGS. 2 and 7, the end 35 of the lever arm 19, is pivotably supported on sleeve spacer/bushing 47 of shackle assembly 45. The lever arm 19 is essentially in longitudinal alignment with the torque arm 21. As mentioned above, the sleeve spacer/bushing 47 supports the forward end of the lever arm 19.

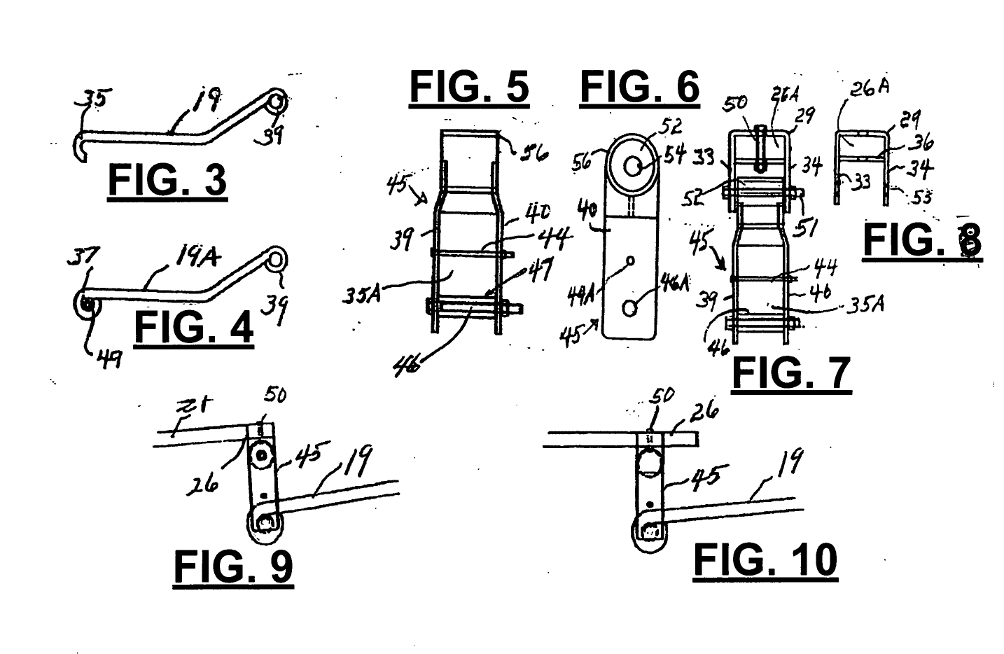

As shown in FIG. 3, the forward end 35 of lever arm 19 may be generally in the form of an “L” or a “C” with the long end of the “L” being the lever arm. This configuration tends to minimize friction between the end 35 of lever arm 19 and the sleeve spacer/bushing 47. Refer now to FIGS. 2, 3, 5 and 7. The limit bolt 44 affixed between plates 39 and 40 of the shackle assembly 45 allows approximately one-half inch of clearance from the top surface of the end 35 of the lever arm 19 to the bolt 44. Bolt 44 thus prevents upward displacement of the end 35 of lever arm 19. The L-shaped, or relatively open configuration of end 35 of lever arm 19 supported on sleeve spacer/bushing 47 reduces production costs, and importantly also minimizes any restrictive friction such as might be caused by a relative tight bushing when there is individual wheel or vertical axle articulation. Thus the unique shackle assembly 45 is structured to support lever arm 19 in a selected alignment relation to the torque arm 21 to provide adequate mounting space for the air spring, and to minimize friction between the lever arm 19 and the shackle 45 mounting.

In an alternative embodiment of the lever arm shown in FIG. 4, the lever arm 19A includes an elongated steel beam or bar member having an eye or loop 37 formed on its front end.

A bushing 49 can be pressed into loop 37 and mounted in shackle assembly 45 by bolt 46 without using a sleeve spacer/bushing 47. It has been found that the mounting of the air spring 16 on the lever arm 19 will reduce the natural frequency of the air spring by approximately 12-15%; however, the presently used common trailing arm arrangement will increase the natural frequency of the air spring 16 by approximately 12-15%.

The air spring supports and isolates approximately 60% of the chassis load and road vibration. In effect, by merging the mechanical set-up of the two elements, the mechanical arrangement of this invention causes one factor to cancel out the other. The result is that the air spring maintains its initial natural characteristics of rate and frequency, in substantially a one to one relation.

In another embodiment of the invention, and referring to FIGS. 9 and 10, by relocating the position of the hanger bracket 29 and thus of shackle assembly 45, forward a short interval of, for example, two or more inches on the torque arm 21, other weight bearing parameters may be obtained. This may be accomplished by providing suitable mounting hole(s) for mounting bolt 50, as indicated in FIG. 10. This positions the forward end of the lever arm 19 relatively closer to the rear axle, and also positions the air spring 16 relatively more forward toward the rear axle. Note, of course, that the torque arm 21 and, or the lever arm 19 may be varied in length to accommodate various models of vehicles. However, the capability of simply moving the position of the shackle assembly 45, including hanger bracket 29, as indicated in FIG. 10, to accommodate various types of vehicles enables the torque arm 21 and the lever arm 19 to be standardized for a number of different models such as light to medium duty trucks.

The arrangement of the torque arm clamped to the axle and forward to a pivot causes this system to become “torque reactive”. This method prevents axle “wind-up”, chassis pitch or rear-end squat during acceleration and front-end nose-dive upon braking. This check of axle “wind-up” will maintain a constant pinion angle that tends to eliminate drive-line vibration and prolong universal joint life. Further, the rigid clamp of the torque arm at the axle prevents chassis roll and yaw, thus eliminating the need of a roll or sway bar assembly.

In this embodiment the air spring 16 is offset from the axle housing 14 and positioned to rest on the lever arm 19. This lever arm arrangement allows the range of travel (up/down) of the air spring 16 to be only a fraction of the travel of the axle housing 14. For example, in one embodiment, for every one inch of travel of the axle housing 14 travels, the air spring 16 travels only 0.73 in to 0.78 in. This results in the air spring 16 being able to operate within the “sweet spot” of its natural frequency/resonance curve over a greater range of travel of the axle housing 14. While this arrangement allows the air spring 16 to operate in its sweet spot over a greater range of travel of the axle housing 14, it does put greater force on the air spring 16. As a result it may be desirable to implement the system with a larger capacity air spring. As these larger capacity air springs will often have greater cross width (CW) dimensions, it may be useful to offset the position of the lever arm 19 inward toward the center of the vehicle to allow for adequate clearance between the air spring 16 and a vehicle tire.

The position of the air spring 16 may be positioned in relation to the chassis 23 and the lever arm 19 dependent on the load bearing requirements by providing various attachment points (indicated at hole 29 in FIG. 2) of the air spring to the lever arm. Thus, the load characteristics of the system 11 may be conveniently tailored for several load bearing classes of vehicles. Further, the geometric arrangement of the lever arm reduces 9 the air spring vertical travel 25% less than that of the axle, thus prolonging the life of the air spring.

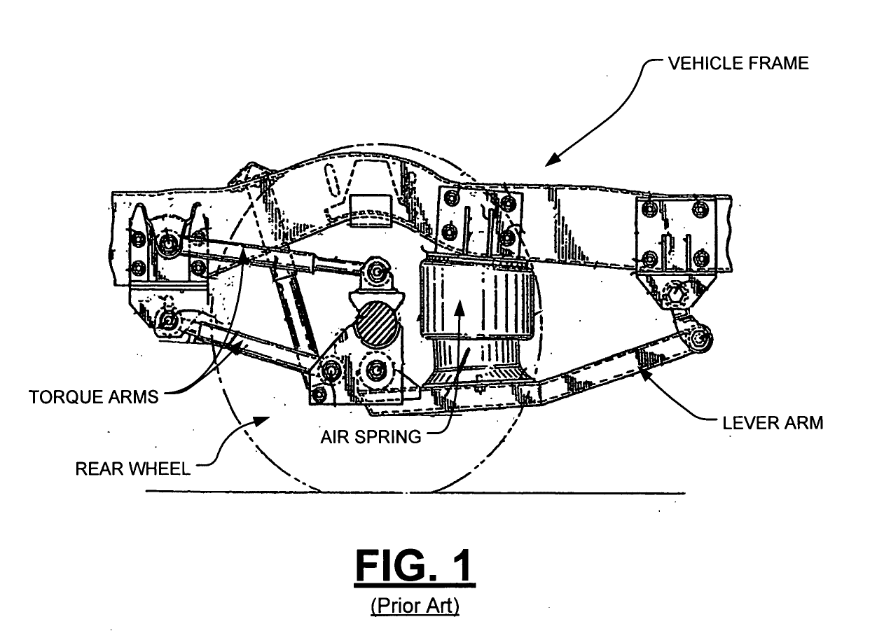

In one embodiment of the invention, as shown in FIG. 1, the lever arm and air spring be implemented so as to support and isolate 78% of the chassis load and road vibrations. For example, the forward end of the lever arm may be placed in a shackle that is vertically connected at the rear end of the cantilever arm. This construction tends to displace approximately 22% of the chassis load into the cantilever arm and hanger bracket forward of the axle.

The following calculations were made on the aforementioned embodiment. The distance from the center of forward hanger 24 and center of the cantilever bushing 25 to the center of the axle 16 is 24.92 inches. The distance from the forward hanger 24 center and center of the cantilever 15 bushing 25 to the center of shackle 45 is 31.94 inches The distance of 24.92 inches divided by the distance of 31.94 inches gives the decimal 0.78; hence, the system provides a 0.78 lifting ratio at the rear shackle position 69 of lever arm 19 and a 0.22 percentage vertical load at the front hanger 24.

In the aforesaid embodiment, the measurement between the center of shackle 45 and the forward end of the lever arm 19 to the center of the air spring is 9.88 inches. The center of the air spring center to lever arm rear pivot center (bushing 69) is 19.13 inches. The distance between the shackle 45 and forward 25 pivot point of the lever arm 19 to the rear pivot point (69)5 of the lever arm is 29.01 inches. The 29.01 inches divided by 19.12 inches results in a 1.51 lever arm ratio. Additional calculations made are set out in TABLE 1 below.

TABLE 1
VEHICLE STATIC LOADS (in pounds)

| Empty Maximum | EMPTY | MAX |
|---|---|---|
| Sprung load on axle each side | 1,021 | 2,792 |
| Cantilever arm/shackle ratio | × .78 | × .78 |
| Cantilever arm sprung load at shackle | 796.38 | 2,177.76 |
| Lever arm ratio | × 1.51 | × 1.51 |
| Sprung load at air spring | 1,205.5 | 3,288.41 |
| Divided by air spring effective area | 32 | 32 |
| Air spring pressure (psi) | 37.5 | 102.76 |
| Sprung vertical load at OEM front hanger | 225.0 | 614.0 |

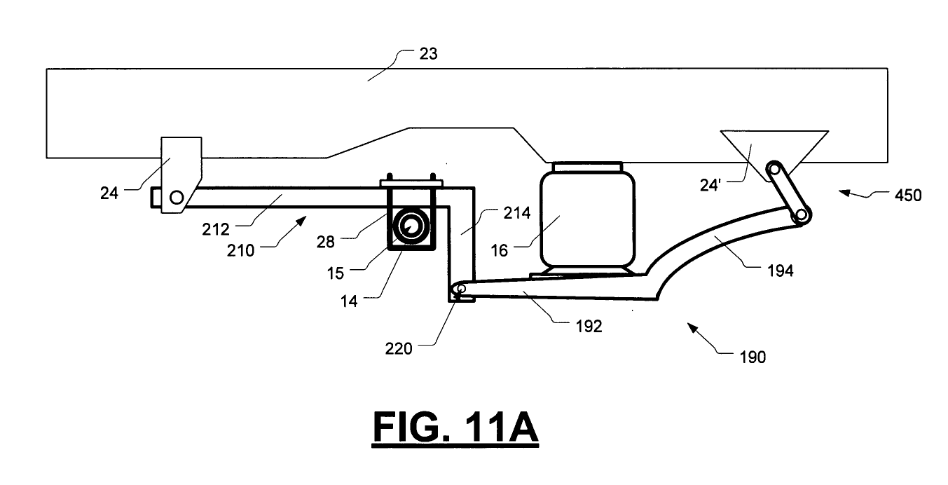

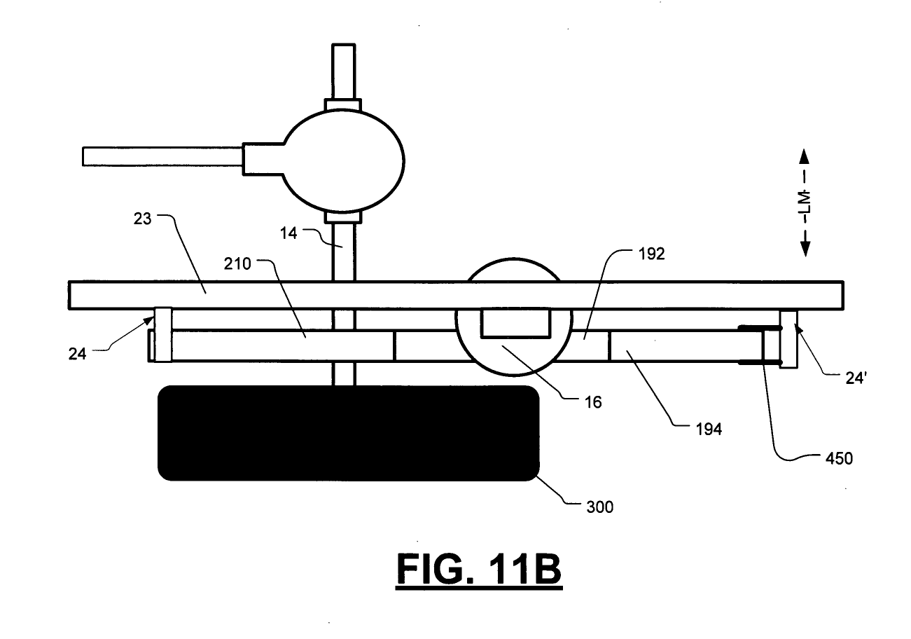

FIG. 11A and FIG. 11B are diagrams depicting a further embodiment of the invention. In this embodiment, a torque arm 210 is provided and is pivotally connected to a lever arm 190 via pivot bolt 220. An air spring 16 is provided and is connected to the lever arm 190. The air spring 16 is positioned so as to extend between the lever arm 190 and the vehicle frame 23. A shackle 450 is provided and is connected between the lever arm 190 and the vehicle frame 23 via, for example, a frame hanger 24′.

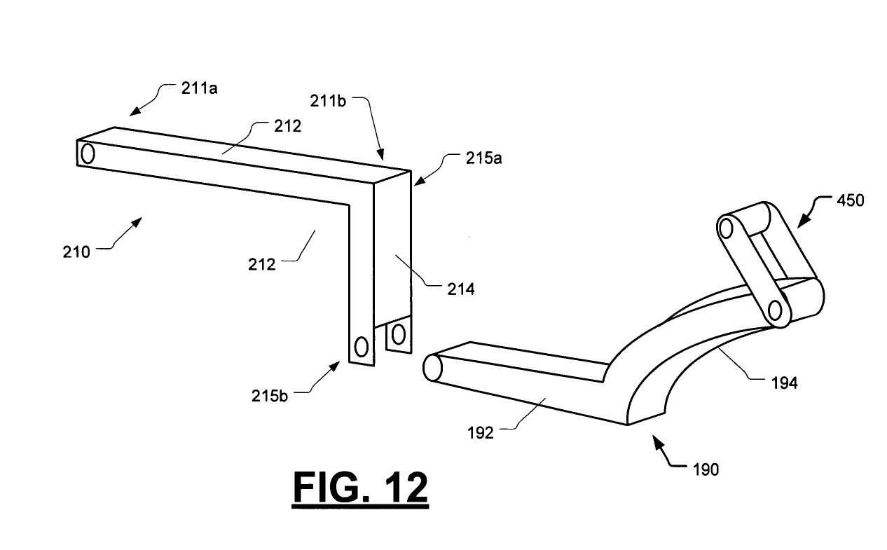

With reference to FIG. 12 it can be seen that in one embodiment, the torque arm 210 includes a first member 212 and a second member 214. First member 212 is preferably connected to second member 214 in a fixed (i.e. non-moving manner). First member 212 may be, for example, wielded or bolted to the second member 214. Other fastening means may also be used. Alternatively, the torque arm 210 may be fabricated as a unity piece.

First member 212 includes a front end 211a and a rear end 211b and is aligned substantially parallel to the frame 23. Second member 214 includes an upper end 215a and a lower end 215b. The upper end 215a of second member 214 is attached to the rear end 211b of the first member 212. The second member 214 is aligned substantially perpendicular to the first member 212, although the second member 214 may be aligned at any desired angle relative to the first member 212.

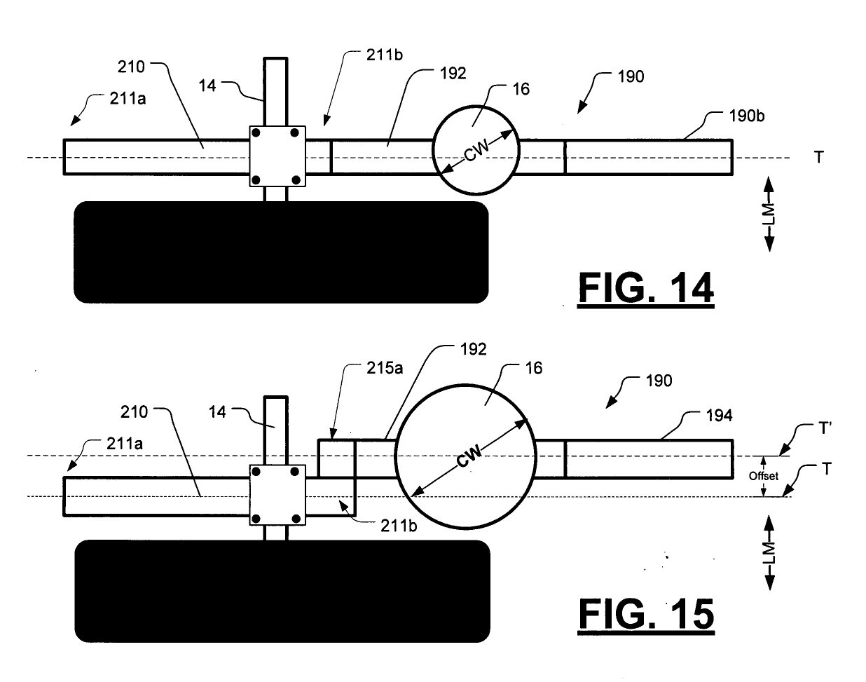

Lever arm 190 includes a forward section 192 and a rearward section 194. The forward section 192 is aligned substantially parallel to the vehicle frame 23 and is pivotally connected to the lower end 215b of torque arm 214 via pivot bolt 220. In this embodiment, the first member 212 is substantially straight in shape and aligned along an axis T (see FIG. 14) that is substantially common with lever arm 190.

The lever arm 190 is connected to the hanger 24□of frame 23 (not shown, see FIG. 10) via a shackle member 450. The shackle member 450 is pivotally connected at one end to the rearward section 194 of the lever arm 190. It is then pivotally connected at the opposite end to the hanger 24□. Frame hanger 24□ may be, for example, a fixed mount on or connected to the frame 23.

In contrast to the embodiment disclosed and discussed above with respect to FIG. 2, the embodiment of FIG. 11 By provides for the location of a shackle member 450 between the rearward section 194 of the lever arm 190 and the frame 23. In this way, only one end of the shackle member 450 can move relative to the frame 23. Thus, reducing the amount of lateral movement LM (movement generally perpendicular to the frame length 23 and parallel to the length of the axle housing 14, see FIG. 11B) experienced by the shackle member 450. Less of movement lateral movement of the shackle member 450 will lessen the likely hood of the shackle member 450 binding during operation (and thereby impeding proper system function). In this way system performance can be enhanced.

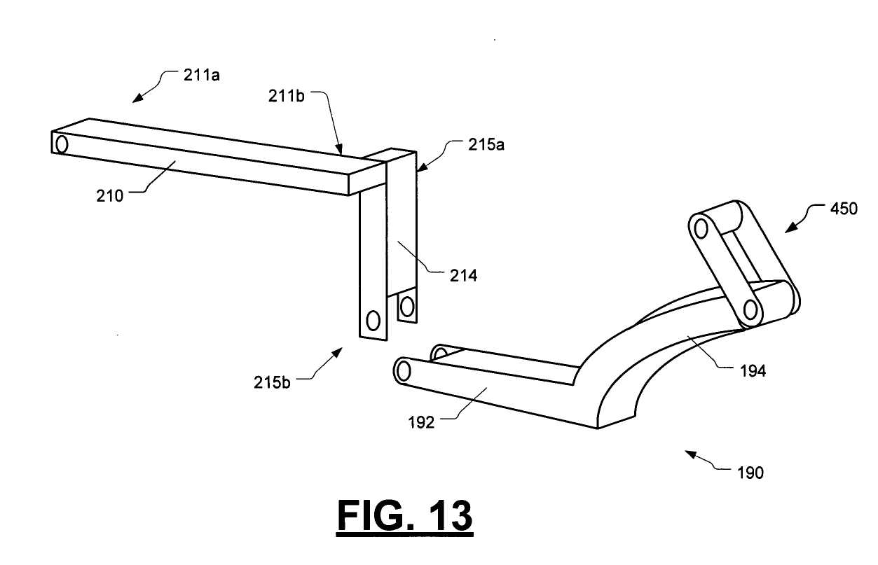

FIG. 13 is a diagram depicting a further embodiment of torque arm 210. In this embodiment, the torque arm 210 is configured to provide an inward (toward the opposite side of the vehicle) offset to allow an air spring 16 having a larger cross width CW (FIG. 15) to be utilized in the system without the air spring 16 coming into contact with a vehicle tire 300. By providing an offset to the torque arm 210, it is possible for the lever arm 190 to be moved inward closer to the interior of the vehicle/frame, thus providing room for a larger air spring 16, if so desired. The rear end 211b of the first member 212 of torque arm 210 is connected to the upper end 215a of the second member 214 of the torque arm 210. However, in this embodiment, the second member 214 is connected to an inner edge/surface (toward the opposite side of the vehicle) of the first member 212. The torque arm 210 is connected to the lever arm 190 via a pivot bolt (not shown) as previously discussed.

FIG. 14 is a diagram depicting a top view showing the relative alignment of one embodiment of the torque arm 210 in relation to the lever arm 190. In this embodiment it can be seen that the torque arm 210 and the lever arm 190 are substantially aligned along a common axis T. Because of the proximity of the forward section 192 of the lever arm 190 to the tire 300, the size of the air spring 16 that can be used in the system is limited.

FIG. 15 is a diagram depicting a top view showing the relative alignment of an alternate embodiment of the torque arm 210 in relation to the lever arm 190. In this embodiment the torque arm 210 has been configured to provide an inward offset between the first member 212 and the second member 214, as discussed above in relation to FIG. 13. From this diagram it can bee seen that the torque arm 210 is aligned along two separate axes (T and T□). More particularly, the first member 212 is aligned along axis T, while the second member 214 is aligned along the axis T□. It will also be noted that the lever arm 190 is aligned substantially along the axis T□.

It should be emphasized that the above-described embodiments of the present invention, particularly, any □preferred□ embodiments, are merely possible examples of implementations, merely set forth for a clear understanding of the principles of the invention. Many variations and modifications may be made to the above-described embodiment(s) of the invention without departing substantially from the spirit and principles of the invention. All such modifications and variations are intended to be included herein within the scope of this disclosure and the present invention and protected by the following claims.

What is claimed:

1- A motor vehicle comprising:
frame;
suspension system attached to the frame;
the suspension system comprises:
torque arm;
lever arm pivotally connected to the torque arm;
shackle member pivotally connected to the lever arm; and
air spring disposed between the lever arm and the frame.

2- The motor vehicle of claim 1, further comprising axle housing connected to the frame via the suspension system.

3- The motor vehicle of claim 2 wherein the axle housing is connected to the torque arm.

4- The motor vehicle of claim 3 wherein the lever arm is pivotally connected to the torque arm via a pivot point located between the air spring and the axle housing.

5- The motor vehicle of claim 4 wherein the torque arm is connected to the frame via a first frame hanger.

6- The motor vehicle of claim 5 wherein the shackle member is connected to the frame via a second frame hanger.

7- The motor vehicle of claim 6 wherein the shackle member is pivotally connected to the second frame hanger.

8- A suspension system for use in a motor vehicle comprising a frame and an axle housing, the system comprising:
torque arm adapted to be connected to the frame of a motor vehicle;
lever arm pivotally connected to the torque arm;
shackle member pivotally connected to the lever arm; and
air spring configured to be disposed between the lever arm and the frame.

9- The system of claim 8 further comprising connector for connecting the torque arm to the axle housing of a motor vehicle.

10- The system of claim 9 further comprising first frame hanger for connecting torque arm to the frame.

11- The system of claim 10 further comprising second frame hanger for connecting the shackle member to the frame of a motor vehicle.

12- The system of claim 9 wherein the lever arm is configured to be pivotally connected to the torque arm at a point located between the air spring and the axle housing of a motor vehicle.

13- A motor vehicle comprising:
frame;
axle housing connected to the frame via a suspension system;
the suspension system comprises:
torque arm;
lever arm pivotally connected to the torque arm;
shackle member pivotally connected to the lever arm; and
air spring disposed between the lever arm and the frame.

14- The motor vehicle of claim 13, wherein the shackle member is further connected to the frame.

15- The motor vehicle of claim 14, wherein the torque arm is further connected to the frame.

16- The motor vehicle of claim 15 wherein the torque arm is further connected to the frame via a first frame hanger.

17- The motor vehicle of claim 16 wherein the shackle member is further connected to the frame via a second frame hanger.
